(19) United States
(12) Patent Application Publication
(10) Pub. No.: US 2025/0222596 A1
(43) Pub. Date: Jul. 10, 2025

(54) SPACE FLEXIBLE GRIPPER DRIVEN BY TINY ENERGY

(71) Applicant: Tongji University, Shanghai (CN)

(72) Inventors: Xiuting Sun, Shanghai (CN); Zhifeng Qi, Shanghai (CN); Jian Xu, Shanghai (CN)

(21) Appl. No.: 18/984,031

(22) Filed: Dec. 17, 2024

(30) Foreign Application Priority Data
Jan. 10, 2024 (CN) 202410036884X

(51) Int. Cl. B25J 15/00; B64G 4/00; F03G 7/06

(52) U.S. Cl. CPC B25J 15/0009; B64G 4/00; F03G 7/06145

(57) ABSTRACT

A space flexible gripper driven by tiny comprises a flexible grasping part and a trigger part; the flexible grasping part comprises a plurality of articulated segments, each of which comprises two mutually articulated grasping plates; the trigger part comprises two movable plates to be close to each other or to be far away from each other; two grasping plates of the first segment are fixed to two movable plates respectively. The invention utilizes an electric signal to trigger the microelectric triggering springs to expand and contract, which indirectly drives two movable plates to be close to each other or to be far away from each other; at the same time, as two mutually articulated grasping plates of the first segment are respectively fixed to two symmetrical movable plates, the mutual approach or mutual distance of the grasping plates of the first segment can be quickly realized.

### TECHNICAL FIELD

The invention belongs to the technical field of space capture devices, specifically relates to a space flexible gripper driven by tiny energy.

### BACKGROUND ART

As human space activities continue to increase, the problem of debris and waste generated in space is becoming increasingly prominent. Such space junk not only poses a potential threat to existing satellites and space stations, but may also lead to debris effects and cause damage to other spacecraft. Therefore, space junk cleanup has become a top priority. Traditional space junk cleanup methods usually rely on rigid robotic arms or thrusters, but these methods present certain challenges when facing debris of different sizes and shapes.

In recent years, robotic systems have been increasingly used in space. A flexible gripper is a mechanical grasping system made of flexible materials that can adapt to grasp objects of various shapes and sizes. Due to the use of lightweight and soft materials, flexible grippers are usually lighter and more flexible than rigid grippers, and are suitable for scenarios that require the machine and equipment to be lightweight and flexible in their movements, increasing the flexibility of the robotic system. Flexible grippers typically have a high degree of freedom, allowing for multi-directional gripping and manipulation. This makes it easier for them to perform tasks in complex environments, such as gripping operations on moving objects.

The important driving methods of current flexible grippers are hydraulic and pneumatic, which have the disadvantages of high cost, high energy consumption, unstable gripping force, etc., respectively, and more importantly, the hydraulic systems and gas compression pumps are difficult to be applied in the space environment. In addition, the current flexible grippers have limited capture space and are mainly used to capture stationary targets, and the success rate of capture is very low for moving targets. In other words, although flexible grippers can be used to capture targets of different shapes and sizes, there are very few space flexible grippers with the ability to capture moving targets, so there is a need to develop a space flexible gripper that is easy to store, has a large capture space, and is able to quickly switch configurations for targets with different moving speeds.

Therefore, how to design a flexible gripper with a small energy trigger configuration switching performance, which can realize the capture function of targets with different moving speeds and shapes, is an urgent problem to be solved.

### SUMMARY OF THE INVENTION

The invention provides a space flexible gripper driven by tiny energy to solve the technical problems of high energy consumption, low capture success rate and low clamping force of the existing space capture device.

The technical solution of the invention to solve the above technical problems is as follows, a space flexible gripper driven by tiny energy, comprising: a flexible grasping part and a trigger part.

The flexible grasping part comprises a plurality of articulated segments, each of which comprises two mutually articulated grasping plates; the trigger part comprises a connecting plate, a rotating shaft, fixing plates, triggering plates, movable plates, microelectric triggering springs, and driving plate groups; the rotating shaft is rotatably connected to a middle of the connecting plate; there are two fixing plates and are fixed in parallel on the connecting plate corresponding to two sides of the rotating shaft; there are two triggering plates and are rotatably connected to the connecting plate; there are two triggering plates and are rotatably connected to two sides of the rotating shaft; there are two movable plates and are located parallel to one side of two triggering plates, and two movable plates are respectively rotatably connected to two sides of the rotating shaft; there are two microelectric triggering springs and are distributed on two sides of the rotating shaft, and the microelectric triggering spring on each side is fixed to the fixing plate and the triggering plate at the same side respectively; there are two groups of driving plate groups and distributed on two sides of the rotating shaft, the driving plate group of each side includes two driving plates articulated with each other and two driving plates of each group are located on one side of the microelectric triggering spring of the same side, and two mutually articulated driving plates of each group at their ends away from each other are hingedly connected with the fixing plate and the movable plate respectively; two grasping plates of the first segment are fixed to two movable plates respectively.

The beneficial effect of the invention is: breaking through the design constraints of the traditional space capture devices, utilizing an electric signal to trigger the microelectric triggering springs to expand and contract, due to the fact that two ends of the microelectric triggering spring are respectively on the same side of the fixing plate and the trigger plate, and due to the fact that two mutually distant ends of two driving plates in each group are respectively hingedly connected with the fixing plate and the movable plate, it is possible to indirectly drive two movable plates to be close to each other or to be far away from each other; at the same time, as two mutually articulated grasping plates of the first segment are respectively fixed to two symmetrical movable plates, the mutual approach or mutual distance of the grasping plates of the first segment can be quickly realized, thereby realizing curling or unfolding of the flexible grasping part, thereby grasping or releasing the space junk, reducing the energy consumption of the flexible gripper, and improving the capture success rate of the flexible gripper.

On the basis of the above technical solution, the invention can also be improved as follows.

Further, the trigger part further includes transmission plate groups, there are two groups of transmission plate groups and distributed on two sides of the rotating shaft, the transmission plate group on each side includes two mutually hinged transmission plates and two transmission plates in each group are located on an inner side of the microelectric trigger spring on the same side, and two transmission plates in each group at their ends away from each other are hingedly connected to the fixing plate and the triggering plate respectively.

A further beneficial effect of adopting the above is that: by utilizing two transmission plates in each group at their ends away from each other are hingedly connected to the fixing plate and the triggering plate respectively, it can convert rotation of the triggering plate into a displacement drive to the hinge connection position of the transmission plate of the same side, destroying the 180° stable configuration of the transmission plate of the same group, and the pre-stretching telescoping springs quickly release energy and shorten their lengths, so that two transmission plates of the same group can quickly approach each other to realize rapid rotation of the movable plate to the fixing plate and increasing the movement speed of the movable plate.

Further, the trigger part also includes positioning pin groups and telescopic springs, and two driving plates of each group are provided with interconnected long strip holes on the plate surfaces close to each other, and positioning holes are provided on the plate surface corresponding to two ends of the long strip holes; there are two groups of positioning pin groups and the positioning pin group of each group comprises two positioning pins, and two positioning pins of each group are correspondingly fixed to the positioning holes of two driving plates of each group; there are two telescopic springs and are fixed on two positioning pins of each group correspondingly, and two telescopic springs can pass through the corresponding long strip holes.

A further beneficial effect of adopting the above is that: two pre-stretched telescopic springs are used to fix and restrict two driving plates of the corresponding group respectively, the movable positions of two movable plates can be indirectly restricted, so as to improve the stability of the movable plates' activities; when driven by a small displacement for triggering the connecting plate, the pre-stretched springs quickly release the energy to realize closure of two driving plates of the same group, and thus realize rapid rotation of the movable plates.

Further, the trigger part further comprises limit plates, there are two limit plates and respectively fixed to any one driving plate of two groups.

The beneficial effect of adopting the above is that when the springs are in the pre-stretched state, the limit plates can make two driving plates of the same group in the same plane, limiting their opening angle to 180°, ensuring stability of the driving plate, and thus ensuring stability of the movable plate.

Further, the grasping plate is a right-angled trapezoidal structure.

Further, there are 11 segments.

Further, the microelectric triggering springs are shape memory alloy springs.

Further, the articulated connections are all realized by pasting adhesive plastic films.

### BRIEF DESCRIPTION OF ACCOMPANY DRAWINGS

FIG. 1 is a stereoscopic structural diagram of a space flexible gripper driven by tiny energy provided by the invention;

FIG. 2 is a front view of a space flexible gripper driven by tiny energy provided by the invention;

FIG. 3 is a side view of a space flexible gripper driven by tiny energy provided by the invention;

FIG. 4 is a stereoscopic structural diagram of the flexible grasping part of a space flexible gripper driven by tiny energy provided by the invention;

FIG. 5 is a stereoscopic structural diagram of segments in the flexible grasping part of a space flexible gripper driven by tiny energy provided by the invention;

FIG. 6 is a front view of the trigger part of a space flexible gripper driven by tiny energy provided by the invention;

FIG. 7 is a side view of the trigger part of a space flexible gripper driven by tiny energy provided by the invention;

FIG. 8 is a stereoscopic structural diagram of the trigger part action of a space flexible gripper driven by tiny energy provided by the invention;

FIG. 9 is a front view of symmetric grasping effect of a space flexible gripper driven by tiny energy provided by the invention;

FIG. 10 is a side view of symmetric grasping effect of a space flexible gripper driven by tiny energy provided by the invention;

FIG. 11 is a front view of left grasping effect of a space flexible gripper driven by tiny energy provided by the invention;

FIG. 12 is a front view of right grasping effect of a space flexible gripper driven by tiny energy provided by the invention.

As shown in the accompanying drawings:
1 flexible grasping part, 11 grasping plate, 2 trigger part, 21 connecting plate, 22 rotating shaft, 23 fixing plate, 24 triggering plate, 25 movable plate, 26 microelectric triggering spring, 27 driving plate, 28 transmission plate, 29 telescopic spring, 30 positioning pin, 31 limit plate, 3 base plate.

### SPECIFIC EMBODIMENT OF THE INVENTION

The principles and features of the invention are described hereinafter in conjunction with the accompanying drawings, and the examples given are for the purpose of explaining the invention only and are not intended to limit the scope of the invention.

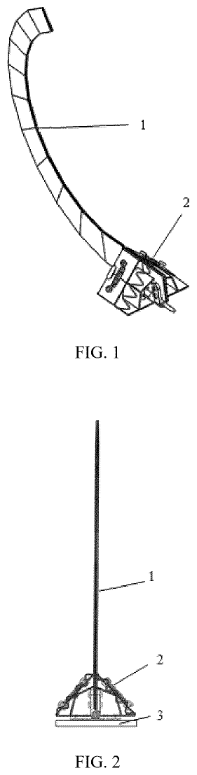

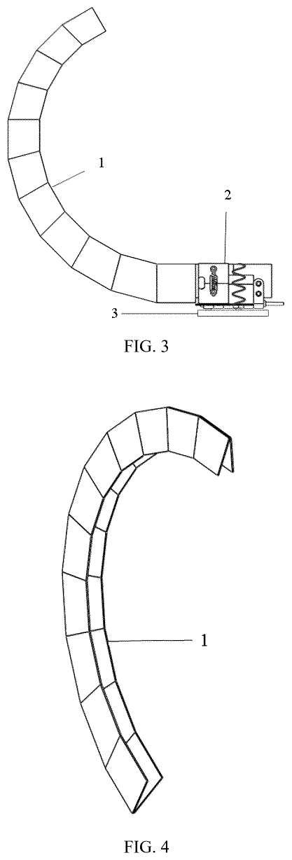

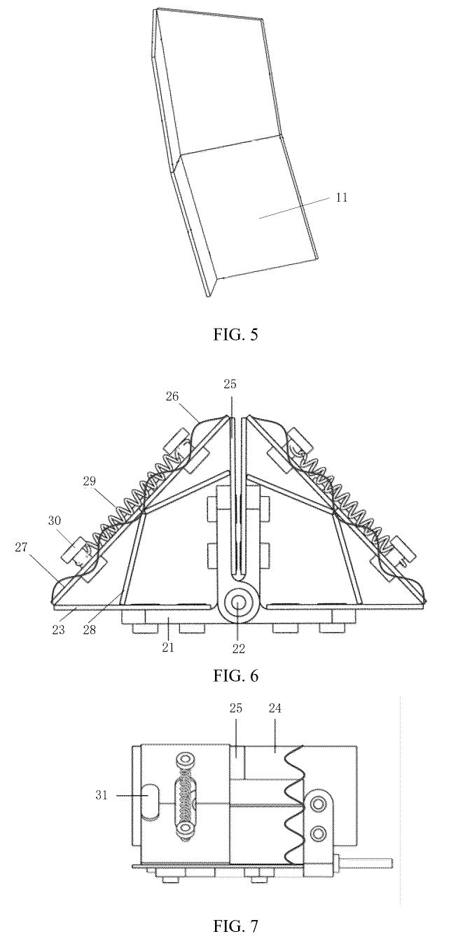

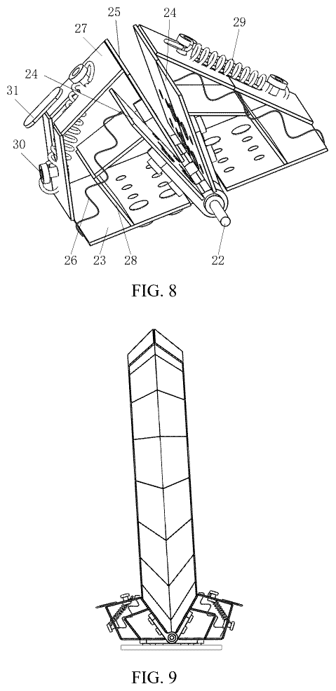

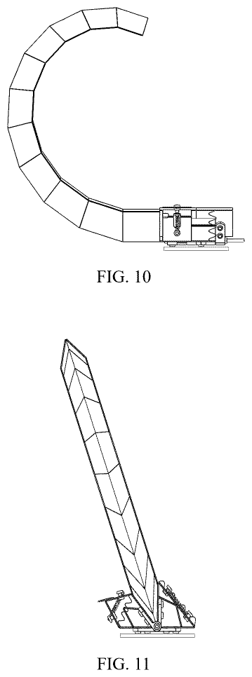

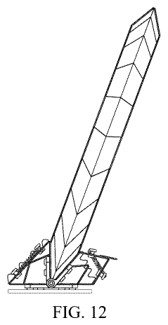

As shown in FIG. 1, a space flexible gripper driven by tiny energy, comprising: a flexible grasping part 1 and a trigger part 2. The flexible grasping part 1 comprises a plurality of articulated segments, each of which comprises two mutually articulated grasping plates 11; the trigger part 2 comprises a connecting plate 21, a rotating shaft 22, fixing plates 23, triggering plates 24, movable plates 25, microelectric triggering springs 26, and driving plate groups; the rotating shaft 22 is rotatably connected to a middle of the connecting plate 21; there are two fixing plates 23 and are fixed in parallel on the connecting plate 21 corresponding to two sides of the rotating shaft 22; there are two triggering plates 24 and are rotatably connected to the connecting plate 21; there are two triggering plates 24 and are rotatably connected to two sides of the rotating shaft 22; there are two movable plates 25 and are located parallel to one side of two triggering plates 24, and two movable plates 25 are respectively rotatably connected to two sides of the rotating shaft 22; there are two microelectric triggering springs 26 and are distributed on two sides of the rotating shaft 22, and the microelectric triggering spring 26 on each side is fixed to the fixing plate 23 and the triggering plate 24 at the same side respectively; there are two groups of driving plate groups and distributed on two sides of the rotating shaft 22, the driving plate group of each side includes two driving plates 27 articulated with each other and two driving plates 27 of each group are located on one side of the microelectric triggering spring 26 of the same side, and two mutually articulated driving plates 27 of each group at their ends away from each other are hingedly connected with the fixing plate 23 and the movable plate 25 respectively; two grasping plates 11 of the first segment are fixed to two movable plates 25 respectively.

In some specific embodiments, the trigger part 2 further includes transmission plate groups, there are two groups of transmission plate groups and distributed on two sides of the rotating shaft 22, the transmission plate group on each side includes two mutually hinged transmission plates 28 and two transmission plates 28 in each group are located on an inner side of the microelectric trigger spring 26 on the same side, and two transmission plates 28 in each group at their ends away from each other are hingedly connected to the fixing plate 23 and the triggering plate 24 respectively.

In some specific embodiments, the trigger part 2 also includes positioning pin groups and telescopic springs 29, and two driving plates 27 of each group are provided with interconnected long strip holes on the plate surfaces close to each other, and positioning holes are provided on the plate surface corresponding to two ends of the long strip holes; there are two groups of positioning pin groups and the positioning pin group of each group comprises two positioning pins 31, and two positioning pins 31 of each group are correspondingly fixed to the positioning holes of two driving plates 27 of each group; there are two telescopic springs 29 and are fixed on two positioning pins 30 of each group correspondingly, and two telescopic springs 29 can pass through the corresponding long strip holes.

In some specific embodiments, the trigger part 2 further comprises limit plates 31, there are two limit plates 31 and respectively fixed to any one driving plate 27 of two groups.

In some specific embodiments, the grasping plate 11 is a right-angled trapezoidal structure.

Specifically, there can be 11 segments.

In some specific embodiments, the microelectric triggering springs 26 are shape memory alloy springs.

In some specific embodiments, it may also comprise a base plate 3, the fixing plates 23 being fixed to the base plate 3.

The invention and its embodiments have been described above, but the description is not limited thereto; only one embodiment of the invention is shown in the drawings, and the actual structure is not limited thereto. In general, it is to be understood by those skilled in the art that non-creative design of structural forms and embodiments that are similar to the technical solutions without departing from the spirit of the invention shall all fall within the protective scope of the invention.

1. A space flexible gripper driven by tiny energy, comprising:
a flexible grasping part, the flexible grasping part comprising a plurality of articulated segments, each of which comprises two mutually articulated grasping plates;
a trigger part, and the trigger part comprises a connecting plate, a rotating shaft, fixing plates, triggering plates, movable plates, microelectric triggering springs, and driving plate groups; the rotating shaft is rotatably connected to a middle of the connecting plate; there are two fixing plates and are fixed in parallel on the connecting plate corresponding to two sides of the rotating shaft; there are two triggering plates and are rotatably connected to the connecting plate; there are two triggering plates and are rotatably connected to two sides of the rotating shaft; there are two movable plates and are located parallel to one side of two triggering plates, and two movable plates are respectively rotatably connected to two sides of the rotating shaft; there are two microelectric triggering springs and are distributed on two sides of the rotating shaft, and the microelectric triggering spring on each side is fixed to the fixing plate and the triggering plate at the same side respectively; there are two groups of driving plate groups and distributed on two sides of the rotating shaft, the driving plate group of each side includes two driving plates articulated with each other and two driving plates of each group are located on one side of the microelectric triggering spring of the same side, and two mutually articulated driving plates of each group at their ends away from each other are hingedly connected with the fixing plate and the movable plate respectively; two grasping plates of the first segment are fixed to two movable plates respectively.

2. The space flexible gripper driven by tiny energy of claim 1, wherein the trigger part further includes transmission plate groups, there are two groups of transmission plate groups and distributed on two sides of the rotating shaft, the transmission plate group on each side includes two mutually hinged transmission plates and two transmission plates in each group are located on an inner side of the microelectric trigger spring on the same side, and two transmission plates in each group at their ends away from each other are hingedly connected to the fixing plate and the triggering plate respectively.

3. The space flexible gripper driven by tiny energy of claim 2, wherein the trigger part also includes positioning pin groups and telescopic springs, and two driving plates of each group are provided with interconnected long strip holes on the plate surfaces close to each other, and positioning holes are provided on the plate surface corresponding to two ends of the long strip holes; there are two groups of positioning pin groups and the positioning pin group of each group comprises two positioning pins, and two positioning pins of each group are correspondingly fixed to the positioning holes of two driving plates of each group; there are two telescopic springs and are fixed on two positioning pins of each group correspondingly, and two telescopic springs can pass through the corresponding long strip holes.

4. The space flexible gripper driven by tiny energy of claim 3, wherein the trigger part further comprises limit plates, there are two limit plates and respectively fixed to any one driving plate of two groups.

5. The space flexible gripper driven by tiny energy of claim 1, wherein the grasping plate is a right-angled trapezoidal structure.

6. The space flexible gripper driven by tiny energy of claim 1, wherein there are 11 segments.

7. The space flexible gripper driven by tiny energy of claim 1, wherein the microelectric triggering springs are shape memory alloy springs.

8. The space flexible gripper driven by tiny energy of claim 1, wherein it also comprises a base plate, the fixing plates being fixed to the base plate.
